(19) United States
(12) Patent Application Publication
(10) Pub. No.: US 2010/0193280 A1
(43) Pub. Date: Aug. 5, 2010

(54) Pressure force device

(76) Inventors: Martin Bareiss, Schwabisch Gmund (DE); Rainer Schanzel, Essingen (DE)

Correspondence Address: Horst M. Kasper, 13 Forest Drive, Warren, NJ, 07059, US

(21) Appl. No.: 12/657,635

(22) Filed: Jan. 25, 2010

(30) Foreign Application Priority Data
Jan. 30, 2009 (DE) 10 2009 000 506.4

(51) Int. Cl. B62D 5/18; F16J 15/02

(52) U.S. Cl. 180/431; 277/590

(57) ABSTRACT

The invention relates to a pressure force device for a gear train (2) in a steering system, with a housing (3), wherein a first gear member (4) is disposed engaged with a second gear member (5) at the housing (3), and with a thrust transmitting member (6), wherein the thrust transmitting member (6) is slidably supported in a guide (8) at the housing (3) along an axis (7), wherein spring element (9) acts onto the thrust transmitting member (6) for pressing the first gear member (4) and the second gear member (5) against each other, wherein the thrust transmitting member (6) is furnished with a circumferential sealing element (10) against an exiting of lubricant from the housing (3). The sealing element (10) is a sealing ring (12) furnished with at least one constriction (11) of its cross-section, wherein a passage of lubricant between the thrust transmitting member (6) and the guide (8) is made possible at the constriction (11) in order to create a pressure force device for gear train of a steering system, which allows a low noise and safe operation.

### BACKGROUND OF THE INVENTION

1. Field of the Invention

The invention relates to a pressure force device for a gear train in a steering system, wherein a first gear member engaged with a second gear member is disposed at a housing and wherein a thrust transmitting member is slidably supported at the housing along an axis in a guide and wherein a spring element acts on to the thrust transmitting member for pressing the first gear member against the second gear member, wherein the thrust transmitting member is furnished with a circumferential sealing element against an exit of the lubricant out of the housing. The invention also relates to a sealing element between a thrust transmitting member and a guide of a gear train of a steering system, wherein the thrust transmitting member serves for pressing a first gear member against a second gear member of the gear train.

2. Brief Description of the Background of the Invention Including Prior Art

The European patent application 1 086 880 A2 describes a steering system formed as a gear rack steering for a motor vehicle with a gear rack slidably guided in an axial direction in a steering gear housing. A pinion gear connected fixed against rotation with a steering handle is inserted into the housing, wherein the pinion gear combs with a toothing of a gear rack. The pinion gear forms a first gear member and the gear rack forms a second gear member. A thrust transmitting member slidably disposed in the guide in the housing along an axis is impacted by a spring element and acts on the rear side of the gear rack and assures a freedom of play between the pinion gear and the toothing of the gear rack. A sealing member formed as an O-ring is inserted in a circumferential groove of the thrust transmitting member and seals the housing of the steering gear train in the region of the guide of the thrust transmitting member together with a cover cap supporting the spring element against losses of lubricant.

It is a disadvantage in connection with such a gear rack steering that the sliding region between the thrust transmitting member and the guide is only insufficiently lubricated. The insufficient lubrication can lead to wear and gear scuffing locations between the thrust transmitting member and the guide. As a consequence of this the thrust transmitting member can bind and seize in the guide of the gear train housing. Based on the binding and seizing, the thrust transmitting member is not any longer pressed at the gear rack or the respective gear train member, whereby clattering and rattling noises can be generated between the pinion gear and the gear rack or between the first gear member and the second gear member.

### SUMMARY OF THE INVENTION

### 1. Purposes of the Invention

It is an object of the present invention to furnish a pressure force device for a gear train of the steering system, which enables a low noise operation.

### 2. Brief Description of the Invention

A pressure force device for a gear train in a steering system is furnished having a housing, wherein a first gear member is disposed at the housing and engages with a second gear member, and with a thrust transmitting member. The thrust transmitting member is slidably supported in a guide along an axis at the housing. A spring element acts onto the thrust transmitting member for pressing against each other of the first gear member and of the second gear member. The thrust transmitting member is furnished with a circumferential sealing element against an exit of lubricant out of the housing. The sealing element is a sealing ring furnished with at least one constriction of its cross-section, wherein a passage of lubricant between the thrust transmitting member and the guide is enabled at the constriction.

A sealing element is furnished between a thrust transmitting member and a guide of a gear train of a steering system. The thrust transmitting member serves for pressing a first and a second gear member of the gear train against each other. The sealing element is a sealing ring furnished with at least one constriction of the cross section of the sealing ring. A passage of lubricant is made possible between the thrust transmitting member and the guide.

A metered access of lubricant to all sliding faces of the thrust transmitting member is enabled and a binding and seizing of the thrust transmitting member, which can entail clattering and rattling noises of the gear train as a consequence, is safely avoided by providing the sealing element as a sealing ring furnished with at least one constraining neck of its cross-section and wherein the constraining neck enables a passage of lubricant between the thrust transmitting member and the guide over the full axial length of the thrust transmitting member. A certain pumping function for lubricant results from an axial shifting motion of the thrust transmitting member itself such that a permanent lubricant supply is enabled.

The constriction is formed by a cross-sectional narrowing of the sealing element to about ⅘ of its cross-section. Several constrictions can be furnished around the circumference of the sealing element. Several constrictions can be furnished around the circumference of the sealing element. The sealing element can be formed as an O-ring. The sealing element can be fixed in a circumferential groove of the of the thrust transmitting member. Eight constrictions can have the same tangential distance (a) to each other and are furnished at the sealing element. The first gear member can be a pinion gear and the second gear member can be a gear rack. The first gear member can be a worm and the second gear member can be a worm wheel. The thrust transmitting member can act onto a bearing of the first and/or second gear member. The steering system can be formed as an auxiliary force steering or foreign force steering with or without superposition function.

According to a particular preferred embodiment of the pressure force device, the sealing element is formed with one or several constricting necks around the circumference of the sealing element with preferably a reduction of cross-section to about ⅘ of its remaining cross-section. The constrictions are preferably disposed at a uniform tangential distance from each other over the circumference of the sealing element. Preferably, the sealing element is an O-ring with a circular cross-section formed out of an elastic or elastomeric material. It can also be advantageous to furnish a cross-section of the sealing element deviating from a circular shape and also to select a cross-section in the constriction region deviating from the circular shape for the sealing element.

According to a particularly preferred embodiment example, the sealing element is laid into a circumferential groove of the thrust transmitting member. The pressure force device is advantageously employed for the pressing against each other of a first gear member formed as a pinion gear and a second gear member formed as a gear rack, wherein the pressure force device is applied to the gear rack steering of a vehicle. The pressure force device can also be applied addition to many possible application regions for the pressing against each other of a worm and a worm wheel, for example in a servo unit of an electrical servo or hydraulic servo steering or foreign force steering. It can be advantageous to allow the thrust transmitting member to operate on the radial shiftably supported bearing of the first gear member or of the second gear member.

The pressure force device with the sealing element according to the present invention is suitable for applications in auxiliary force or foreign force steering systems with or without superposition function.

The invention is now described in more detail by way of an embodiment example and is presented by way of the accompanying drawing.

### BRIEF DESCRIPTION OF THE DRAWING

There is shown in the drawing:

FIG. 1 a partial cross-section of a gear rack auxiliary force steering in the region of the pressure force device,

FIG. 2 a top planar view onto a sealing element according to the present invention,

FIG. 3 a partial longitudinal section through a worm gear with pressure force device.

### DESCRIPTION OF INVENTION AND PREFERRED EMBODIMENT

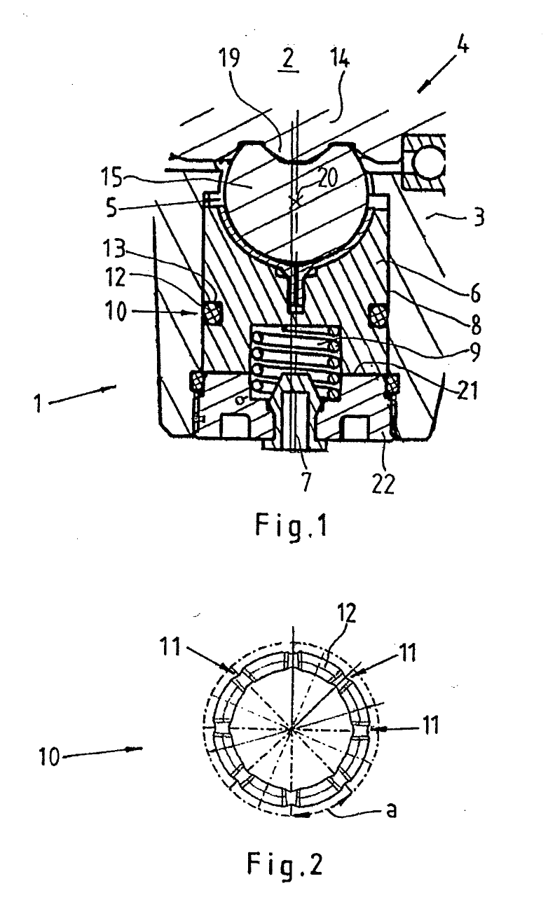

A steering system, which is formed as a gear rack auxiliary force steering for a motor vehicle, is shown in FIG. 1 in part in a cross-section through the gear train 2. A housing 3 formed as a gear train housing is here shown in axial direction relative to a gear rack 15 in the region of a pressure force device 1. The gear rack 15 carries a toothing 19 extending in axial direction over the gear rack 15, wherein the toothing 19 is in engagement with a pinion gear 14 connected fixed against rotation to a steering shaft at an end of the steering shaft. The pinion gear 14 is rotatably supported in a housing 3 in a way not illustrated in detail and forms a first gear member 4. The gear rack 15 shifts in axial direction depending on a rotation of the pinion gear 14 at the steering handle at the steering shaft. The gear rack 15 forms a second gear member 5 and is with steering tie rods and wheel steering levers connected to the steerable wheels of the motor vehicle.

The toothing 19 of the gear rack 15 is pressed against the pinion gear 14 with the aid of a pressure force device 1 comprising a thrust transmitting member 6, which is disposed along an axis 7 located perpendicular to the longitudinal axis 20 of the gear rack 15 and of a guide 8 recessed in the housing 3 of the gear train 2. The thrust transmitting member 6 can be formed of cylindrical or cubic shape.

A spring element 9, which is inserted in the guide 8, is supported at a floor 21 of the thrust transmitting member 6, and wherein the floor 21 is formed as a planar face and wherein the spring element 9 is supported at a cover cap 22 fixed in the guide 8. A sealing element 10 made out of an elastomeric material and formed as an O-ring 12 is inserted in a circumferential groove 13 of the thrust transmitting member 6. The O-ring 12 decreases the flow of lubricant from the interior of the housing to the cover cap 22, however reduces the flow of lubricant not completely, since the O-ring exhibits eight constriction necks 11 in its cross-section. The constricting necks 11 are disposed over the circumference of the O-ring 12 at equal tangential distances a and enable a metered passage of lubricant along the surface of the thrust transmitting member 6 such that this surface of the thrust transmitting member 6 overall is supplied with lubricant. A scuffing of the thrust transmitting member 6 at the guide 8 based on a lack of lubricant in the axial region of the thrust transmitting member 6 between the O-ring 12 and the cover cap 22 is thereby avoided, similarly a too large migration of lubricant is avoided in the region of the spring element 9, whereby an interference with the mobility of the thrust transmitting member 6 would occur.

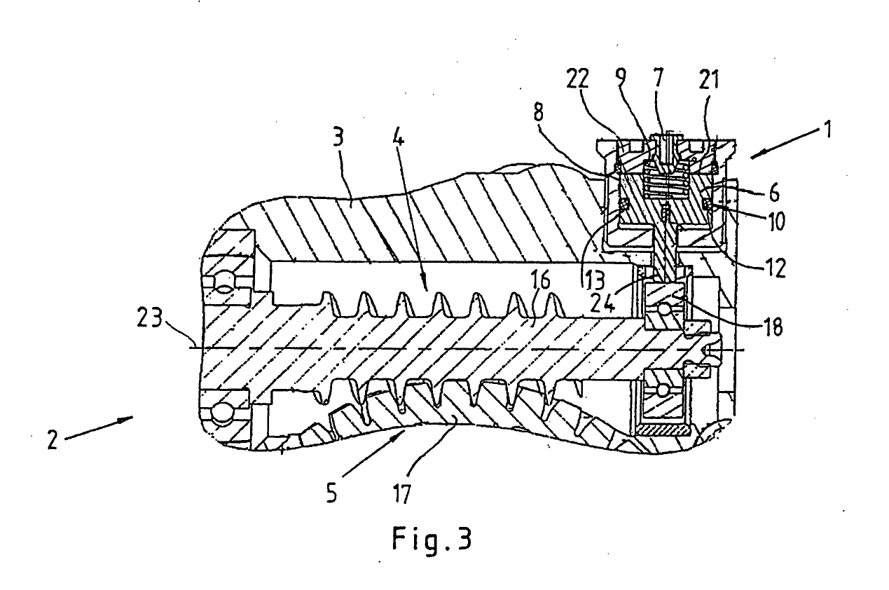

The pressure force device 1 can also be employed for other purposes such as for pressing a first gear member 4 formed as a worm 16 against the second gear member 5 formed as a worm wheel 17 as shown in FIG. 3 in a longitudinal section along an axis 23 of a worm 16 of a worm wheel gear. The worm wheel gear is preferably employed for force transmission of a servo motor in a steering column drive, a pinion drive or a double pinion drive of an electrical servo steering. The worm 16 is supported in the housing 3 at a radially shiftable bearing 18, wherein the radially shiftable bearing 18 is disposed at an axial end of the worm 16. The worm 16 is connected fixed against rotation with a servo motor not shown here and engages with a worm wheel 17. The worm wheel 17 forms as a second gear member 5 the drive side of the gear train 2.

In order to assure freedom of play in the toothing engagement of the bomb 16 end of the worm wheel 17 independent of wear, thermal expansion and alike during operation of the gear train, the pressure force device 1 is disposed in the housing 3 in the same kind of construction in principle as shown in FIG. 1, wherein an end 24 of the thrust transmitting member 6 acts on the bearing 18 and presses the worm 16 in a radial direction relative to the axis 23 of the worm 16 toward the worm wheel 17. The bearing 18 is for this purpose is supported radial shiftable in a link guide in the housing 3.

The constrictions 11 shown in FIG. 2 are round, wherein the toroidal central ring of the O-ring 12 coincides with the central axis of the round constriction. Alternatively, the round constrictions can be positioned such that the inner side of the O-ring and the inwardly positioned surface of the round constrictions form a common inner circle. In other words, the center axis of the constrictions is disposed at a distance from the toroidal center circle of the O-ring 12. The O-ring 12 can have different kinds of constrictions. The locations of the constrictions can be confined to the outer side of the O-ring 12 or they can be confined to the inner side of the O-ring 12 or they can be alternating on the outer side and on the inner side of the O-ring 12. The constrictions can be formed like notches or semi cylinders having their axes disposed parallel to the axis of the O-ring 12 and positioned on the outer periphery or the inner periphery of the O-ring 12.

The same reference characters hold for the same device components.

### LIST OF REFERENCE CHARACTERS

1 pressure force device
2 gear train
3 housing
4 first gear member
5 second gear member
6 thrust transmitting member
7 axis
8 guide
9 spring element
10 sealing element
11 constriction neck
12 O-ring
13 circumferential groove
14 pinion gear
15 gear rack
16 worm
17 worm wheel
18 bearing
19 toothing, toothed wheel work
20 longitudinal axis of 15
21 floor
22 cover cap
23 axis
24 end of thrust transmitting member
a tangential distance

1. A pressure force device for a gear train (2) in a steering system, with a housing (3), wherein a first gear member (4) is disposed at the housing (3) engaged with a second gear member (5), and with a thrust transmitting member (6), wherein the thrust transmitting member (6) is slidably supported in a guide (8) along an axis (7) at the housing (3), wherein a spring element (9) acts onto the thrust transmitting member (6) for pressing against each other of the first gear member (4) and of the second gear member (5), wherein the thrust transmitting member (6) is furnished with a circumferential sealing element (10) against an exit of lubricant out of the housing (3), wherein the sealing element (10) is a sealing ring (12) furnished with at least one constriction (11) of its cross-section, wherein a passage of lubricant between the thrust transmitting member (6) and the guide (8) is enabled at the constriction (11).

2. The pressure force device according to claim 1, wherein the constriction (11) is formed by a cross-sectional narrowing of the sealing element (10) to about ⅘ of its cross-section.

3. The pressure force device according to claim 1, wherein several constrictions (11) are furnished around the circumference of the sealing element (10).

4. The pressure force device according to claim 1, wherein several constrictions (11) are furnished around the circumference of the sealing element (10).

5. The pressure force device according to claim 1, wherein the sealing element (10) is formed as an O-ring (12).

6. The pressure force device according to claim 1, wherein the sealing element (10) is fixed in a circumferential groove (13) of the of the thrust transmitting member (6).

7. The pressure force device according to claim 1, wherein eight constrictions (11) having the same tangential distance (a) to each other are furnished at the sealing element (10).

8. The pressure force device according to claim 1, wherein the first gear member (4) is a pinion gear (14) and wherein the second gear member (5) is a gear rack (15).

9. The pressure force device according to claim 1, wherein the first gear member (4) is a worm (15) and wherein the second gear member (5) is a worm wheel (17).

10. The pressure force device according to claim 1, wherein the thrust transmitting member (6) acts onto a bearing (18) of the first and/or second gear member (4, 5).

11. The pressure force device according to claim 1, wherein the steering system is formed as an auxiliary force steering or a foreign force steering with or without superposition function.

12. A sealing element between a thrust transmitting member (6) and a guide (8) of a gear train (2) of a steering system, wherein the thrust transmitting member (6) serves for pressing a first and a second gear member (4,5) of the gear train (2) against each other, wherein sealing element (10) is a sealing ring (12) furnished with at least one constriction (11) of its cross section, wherein a passage of lubricant is made possible between the thrust transmitting member (6) and the guide (8).

13. A pressure force device for a gear train in a steering system comprising
a housing;
a first gear member disposed at the housing;
a second gear member engaged with the first gear member;
a guide;
an axis of the guide;
a thrust transmitting member, wherein the thrust transmitting member is slidably supported in the guide along the axis at the housing;
a spring element acting onto the thrust transmitting member for pressing the first gear member and the second gear member against each other;
a circumferential sealing element furnished to the thrust transmitting member against an exit of lubricant out of the housing, wherein the circumferential sealing element is a sealing ring furnished with at least one constriction of its cross-section, wherein a passage of lubricant between the thrust transmitting member and the guide is enabled at the constriction.
